(19) United States
(12) Patent Application Publication
(10) Pub. No.: US 2012/0323924 A1
(43) Pub. Date: Dec. 20, 2012

(54) METHOD AND SYSTEM FOR A MULTIPLE DATABASE REPOSITORY

(76) Inventor: Justin A. Okun, Lake Forest, CA (US)

(21) Appl. No.: 13/162,090

(22) Filed: Jun. 16, 2011

(51) Int. Cl. G06F 17/30

(52) U.S. Cl. 707/741; 707/770; 707/E17.014; 707/E17.049

(57) ABSTRACT

Method, system, and programs for creating partitioned or fragmented log files during data logging to better manage file size, more easily facilitate data retrieval and file optimization. In an embodiment, typically large monolithic log files are fragmented or divided into smaller files that can be searched, stored, vacuumed and retrieved more easily.

### FIELD

The instant disclosure relates to methods, systems and programming for managing large data files. Particularly, the instant disclosure is directed to methods, systems, and programming for managing large log files by portioning them into smaller, more manageable files.

### BACKGROUND

Computer system records often contain host operating statistics for the host system that may be used in generating reports on workload group goal compliance and system resource consumption. That is, system operational statistical data such as processor errors, processor statistics, memory usage, CPU operation times, CPU cycles, etc. may be recorded and logged into a file on the system or on a standalone management server or system. These records are often delivered in a binary format to a workload manager client via an extraction process where the binary records are parsed and imported into a single monolithic file or database, such as an SQLite v3 database, often referred to as a statistics repository file.

Over time, however, this file may grow to be very large (80+ gb), especially when used with hosts that are recording statistics for several processes. When files grow to this size, management and manipulation problems may occur and often performance degradation and other issues are experienced.

For example, over time such large monolithic database records may become increasingly fragmented and degrade report rendering performance. Operating systems may have a difficult time managing such large files and manipulating such a large file becomes increasingly time intensive.

Standard file compression techniques used for NT File Systems (NTFS) do not work on files larger than 60 GB in size despite the fact that SQLite database can usually compress 8:1 with little degradation in disk read performance. Such compression may be implemented using various known vacuuming techniques. Vacuuming is a known technique used to reduce SQLite v3 databases, to improve performance, however, it is a time intensive operation and becomes prohibitively expensive once the database file grows beyond 10 GB.

Accordingly, a need exists for a system and method for managing large sized database files, that allows for improved access speed, reduced fragmentation, and reduce file size. The present disclosure addresses such limitations by providing a system and method for dividing large repository files into several smaller, more manageable, database files, organized by criteria such as time.

### SUMMARY

In an embodiment, the increase in manageability of large monolithic repository records or files is achieved by partitioning the stored data into smaller separate databases.

In one embodiment, a method, for partitioning files on a machine having at least one processor, storage, and a communication platform comprises the steps of storing data, received over the communications platform, in a database. Tracking a criteria for the data utilizing at least one processor and partitioning the database into a plurality of databases based on the criteria while maintaining an index of the plurality of databases.

In one embodiment, the criteria are at least a temporal limit, a size limit, a data source, a data type and a geographic limit. In another embodiment the index contains characteristics of the plurality of databases. In still another embodiment, the characteristics of the plurality of databases include one of the following: a database name, a server name, a start time, an end time, a system path and a status identifier.

In another embodiment, the processor computes the amount of free space in the plurality of database, and stores an amount of additional information in the plurality of databases based on the computing step. In one embodiment, an additional one of a plurality of databases is created if the computed amount of free space is less then the amount of additional information.

In an embodiment, a method for retrieving information from a plurality of databases on a machine having at least one processor, storage, and a communication platform comprises creating a table comprising characteristics of the plurality of databases and receiving a query on the machine. The processor processes the query to determine the location of the information within the plurality of databases based on a characteristics in the table and retrieves the information from the plurality of databases. The retrieved data is communicated over the communications platform back to the machine.

In an embodiment, the database sizes of the plurality of databases are limited so that an individual database can be vacuumed using known techniques. In another embodiment, the vacuuming of the individual databases can be completed within 2 to 6 hours. In still another embodiment, the database sizes of the plurality of databases is limited to a size such that an NTFS compression scheme may be applied to plurality of databases

In another embodiment, a machine readable non-transitory and tangible medium having information recorded thereon for partitioning files on a machine having at least one processor, storage, and a communication platform, to causes the machine to perform the following is disclosed. The storing of data, received over the communications platform, in a database, tracking a criteria for the data utilizing at least one processor and partitioning the database into a plurality of databases based on the criteria. Finally, the system maintains an index of the plurality of databases.

In a further embodiment, the criteria is at least one of the following: a temporal limit, a size limit, a data source, a data type and a geographic limit. In still another embodiment, the index contains characteristics of the plurality of databases.

In another embodiment, the characteristics include at least one of the following: a database name, a server name, a start time, an end time, a system path and a status identifier.

In another embodiment, a system for partitioning files comprises a first system for implementing a first application and a data capture system for receiving data from the first system. A communications link for conveying the data from the first system to a data capture system and a data partitioning system for partitioning the data into partitioned data files. The embodiment further includes a data storage system for storing the partitioned data files, and a data indexing system for tracking the partitioned files.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 illustrates a schematic representation of a system in accordance with an embodiment of the present disclosure;

FIGS. 2a and 2b illustrate schematic representations of file systems in accordance with an embodiment of the present disclosure;

FIGS. 3a and 3b illustrate schematic representations of data file population scenarios in accordance with an embodiment of the present disclosure;

FIGS. 4a and 4b illustrate schematic representations of data file population scenarios in accordance with an embodiment of the present disclosure;

FIGS. 5a and 5b illustrate schematic representations of data file population scenarios in accordance with an embodiment of the present disclosure;

FIG. 6 illustrates a schematic representations of open file space scenario in accordance with an embodiment of the present disclosure;

FIG. 7 illustrates a schematic representations of open file space scenario in accordance with an embodiment of the present disclosure;

FIG. 8 illustrates a schematic representation of a system in accordance with an embodiment of the present disclosure;

FIG. 9 illustrates a general computer architecture on which the instant disclosure can be implemented in accordance with an exemplary embodiment.

### DETAILED DESCRIPTION

In the following detailed description, numerous specific details are set forth by way of examples in order to provide a thorough understanding of the relevant teachings. However, it should be apparent to those skilled in the art that the instant disclosures may be practiced without such details. In other instances, well known methods, procedures, components, and/or circuitry have been described at a relatively high-level, without detail, in order to avoid unnecessarily obscuring aspects of the instant disclosures.

The instant disclosure relates to methods, systems, and programming for managing large log files by portioning them into smaller more manageable files.

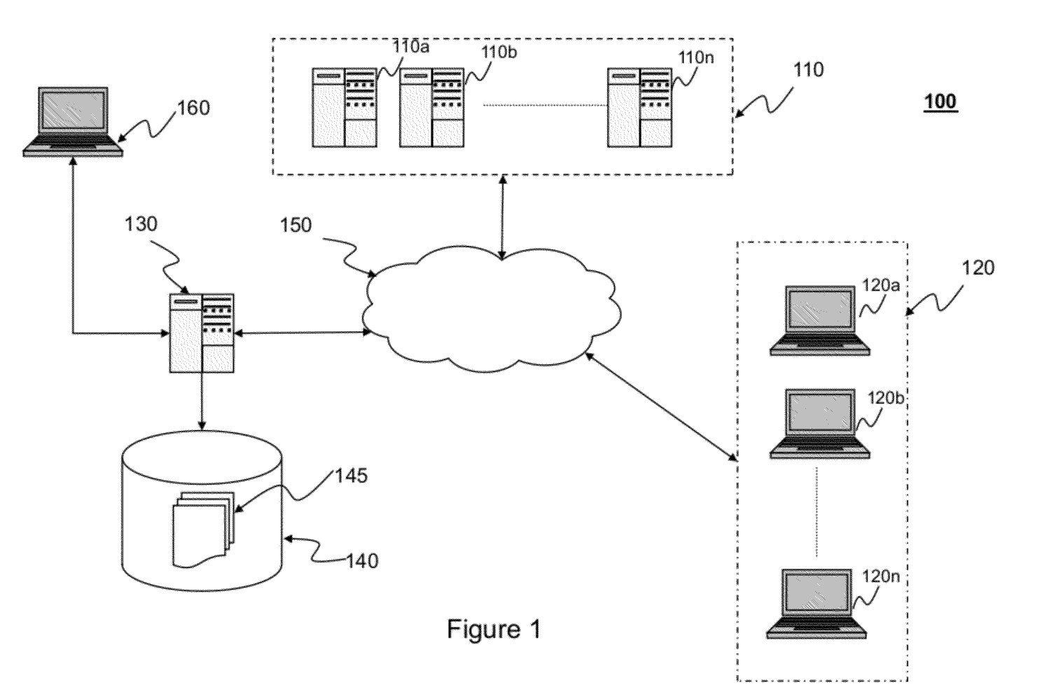

FIG. 1 depicts a system 100 in accordance with an embodiment of the present disclosure. System 100 may comprise computers, servers, or processors 110, user input terminals or computers 120, management server 130, database 140, fragmented files 145, network 150, and user terminal 160.

Servers 110 may be a single server or processor or may be made up of several servers, processors or hosts 110a, 110b, . . . 110n. Each server or processor 110a to 110n may be running a separate process or the same process, may be running on a separate server or the same server. User terminals 120a to 120n may be computers running their own processes or may be terminals connected to network 150 and accessing a remote host such as servers 110a to 110n. Both servers 110 and terminals 120 may be wired or wirelessly connected directly to network 150 or may wired or wirelessly connected directly to management server 130.

Network 150 in system 100 can be a single network or a combination of different networks. For example, a network can be a local area network (LAN), a wide area network (WAN), a public network, a private network, a proprietary network, a Public Telephone Switched Network (PSTN), the Internet, a wireless network, a virtual network, or any combination thereof. A network may also include various network access points, e.g., wired or wireless access points such as base stations or Internet exchange points through which an input source may connect to the network in order to transmit information via the network.

Server or host 130 may be a management server used to gather statistics about the operations, errors, and performance of system 110. It may be implemented on a standalone machine as depicted in FIG. 1 or may be implemented on a server such as 110a. Database 140 may be an SQLite database although other databases formats such as relational databases and flat files would be appropriate. Traditionally, database 140 contained a single monolithic file comprised of all data logs generated and collected by server 130. Such a monolithic file could grow extremely large over time and could exceed 80 GB in size. In one embodiment, database 140 contains a series of fragmented files 145 rather than a large monolithic file. Fragmented files 145 can be organized and sorted based on various criteria such as file size, data source, data type, host, or process. All the fragmented files are then saved in a repository, such as database 140 or some other file storage system or medium such as a floppy disk, a flexible disk, hard disk, magnetic tape, any other magnetic medium, a CD-ROM, DVD or DVD-ROM. In an embodiment, fragmented files 145 may be organized by host, i.e., all messages from a single host are contained in a separate fragmented file. Organization by host, in an embodiment, allows for easy retrieval of information related to the host as well as simpler indexing, since all the information within the fragmented file is related to a unique host. However, organization of fragmented file 145 by host alone can lead to potentially large files, if the host serves several busy clients. Similarly, in an embodiment, the files are organizing by size, i.e., only allowing a fragmented file 145 to grow to a certain size before another fragmented file is created. This allows for the creation of manageable file sizes that can be more easily vacuumed, stored, indexed and compressed.

Fragmented files 145 may be stored of conveyed in many forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more output sequences of one or more outputs for further processing or execution. Fragmented files 145 may be conveyed back to network 150 or may be stored in database 140 for future use.

As will be appreciated by those skilled in the art, more than one criterion may be utilized to form the fragmented files 145. In an embodiment, both host and period can be used to ensure optimal fragmented file size.

In an embodiment, the fragment files are arranged by date/time and are fragmented based on a set period of time, such as a calendar month or size, or host. In this embodiment, specific fragmented files 145 could be removed from database 140 either for analysis or deletion, without impacting the other remaining fragmented files 145. Without fragmentation, removal of specific periods of data from a monolithic file were not possible or were extremely burdensome.

In one embodiment, infrastructure equipment, such as user terminal 160 and management server 130 may transparently retrieve and collect data from fragmented files 145 in response to queries without having to query separate fragmented files. That is, in an embodiment the fact that the large monolithic database had been broken down into small fragmented files 145 is invisible to the user at terminal 160. A request for data from terminal 160 will search, query, and retrieve data from all fragmented files 145 and not just a fragmented file associated with a particular host or server or process. In order to accomplish this, in an embodiment, the queries need to be wrapped behind function calls that accessed all databases without user intervention. The wrapped function calls pull data from all fragmented files without regard as to where the records are being pulled from.

In an embodiment, the existing or core repository may be considered the “primary” repository. Such a core or primary repository will have a new table named “database” that will contain information about all the “individual” fragmented files created based on the size and host. For each individual database or fragmented file created, there will be information about the host, start and end timestamp of records, database path and state. Such information may be stored in a table.

TABLE 1

| | | | | | |
|---|---|---|---|---|---|
| db_{—} | host_{—} | start_nominal_{—} | end_nominal_{—} | db_{—} | db_{—} |
| id | id | timestamp | timestamp | path | state |

| | | | | |
|---|---|---|---|---|
| - - - | - - - | - - - | - - - | - - - |

Furthermore, the field db_state may indicate whether the file is full or not. Once a database is full, it will become a candidate for vacuuming. Each binary extraction will either create a new entry in the “database” table or start and end timestamp of an existing record will be updated based on the new records imported.

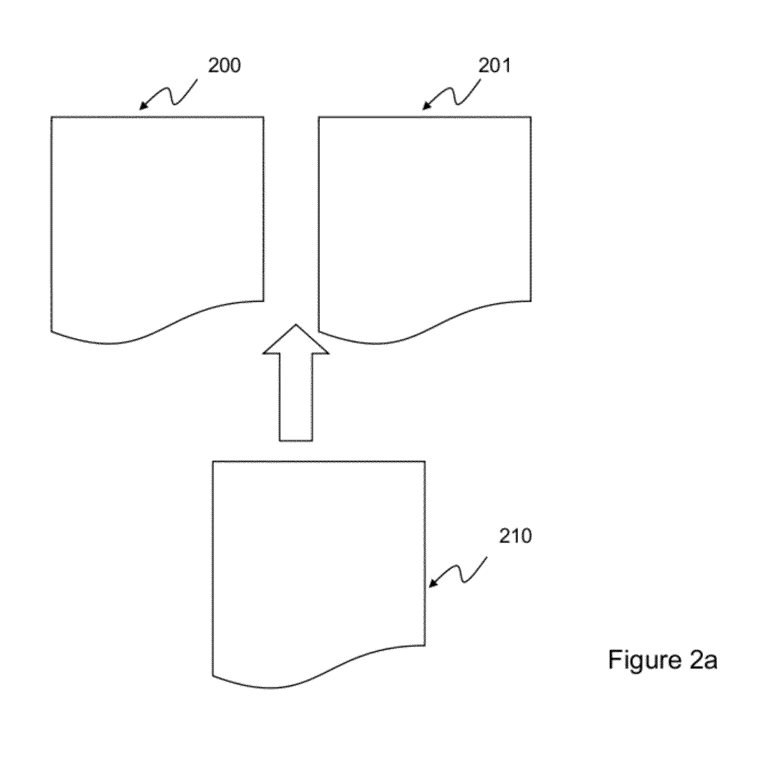

In another embodiment, the system is capable of inserting records from other sources, such as binary statistics files and stand alone statistics archives into the fragmented files based on the record timestamp. This embodiment must deal with the complexities of distributing records across individual repository database files. For example, as seen in FIG. 2a, file 210 may contain records from a separate system that needs to be inserted into fragmented files 200 and 201. Fragmented file 200 may contain data from May 1 to May 31 and file 201 may contain data from June 1 to June 3. File 210, however may contain records that cross the boundary of a single month i.e., contains data from May 15 to June 15. Records from file 210 therefore needs to be inserted transparently into the appropriate fragmented files, i.e., files 200 and 201 of the repository.

In an embodiment, as seen in FIG. 2b the system may create a new fragmented file for the repository 250b when necessary and as needed. For example, if the repository contains files 200b, and 201b which correspond to data for September 2010 and November 2010, respectively, and the records 205b are being imported for the month of October 2010, a file 210b will be created to contain that month's records since the appropriate file does not already exist. Records 205b will be moved into file 210b which will then be placed between fragmented files 200b and 201b in the repository 250b of fragmented files.

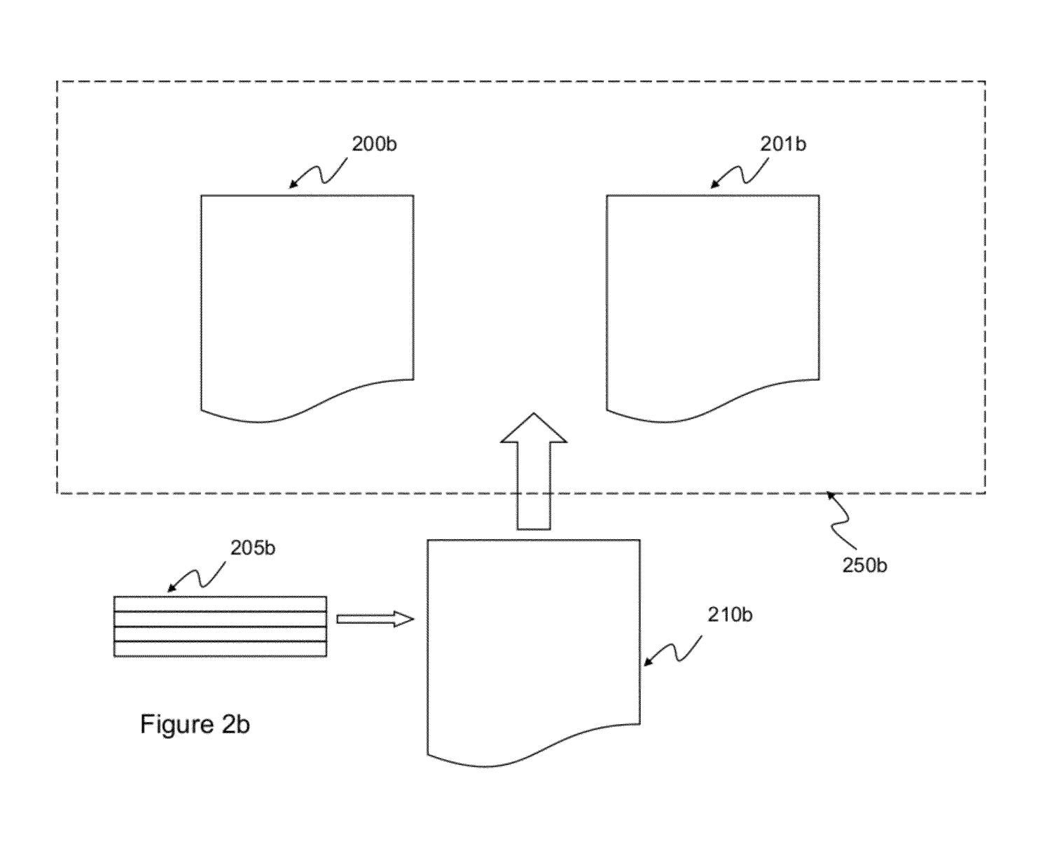

In an embodiment, when a binary file is imported into the repository, the system must decide whether a new database 210 should be created or an existing database 200 or 201 can be used as a target database. To do this, the system must determine if any of the binary records from the new binary file 210 need to be imported into the core database 250b. With reference to FIG. 3a, if start timestamp of current extraction et1 falls in the range of records that are present in the core repository 300, part of the imported records will go into the core repository 300 and it will be a replacement of the existing record. In this case the start timestamp of binary file extraction 310 is contained in the core repository 300, so binary data from time et1 to ct2 will be imported into the core repository 300. If time range et1-et2 was fully contained within ct1-ct2, then all the records from the binary extraction 310 will go into the core database 300. Accordingly, after the initial step, start timestamp of records left to import will always be beyond records in the core database 300. As seen in FIG. 3b, if timestamp et1 was outside, i.e., greater than ct2, then no records will be imported into the core database 300.

Assuming that there is no individual database created, records in binary file 310 starting from timestamp ct2 will go into a new database. When the new database is created, its free size will be tracked during the import process and once its size exceeds the maximum allowed size, a new database will get created. As each successive database reaches a maximum size, a new database file is created.

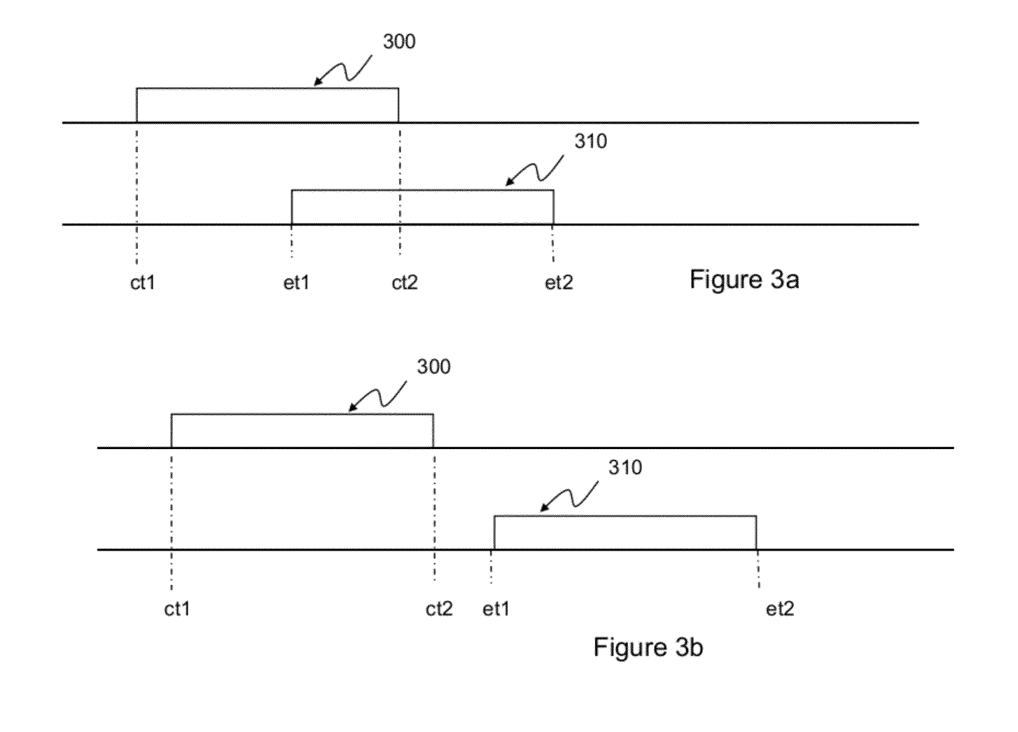

As seen in FIG. 4a, in the case where the time range of binary records 410 left to import into an existing database 420 overlaps then some or all records can go into it. For example, consider individual database 420 with time range, it1 to it2 and binary records with the time range of nt1-nt2. In this case records 410 in time range nt1-it2 (including records with time stamp it2 referred as balance interval it2 here after) will be imported into existing database 420. During the import process, no size limit checking will be done on database 420 because the system is merely replacing records and not adding new records. Only an upper time limit it2 is put on the parsing process. When parsing/import code encounters a balance interval exceeding it2 then it stops further parsing and importing. For the remaining records whose timestamp is more than it2, either the existing database 420 can be extended if some free space is available or a new database may be created. If time range nt1-nt2 is fully contained in the it1-it2, then all records 410 will get imported into the existing database 420 without any check on limits.

If the database 420 has free space then it can be extended to accommodate all of the records in 410. Consider existing database 420b in FIG. 4b having records with a time range from it1-it2 and new records 410b having a time range of nt1-nt2. There is a time gap 430b between it2 of existing database 420b and start time nt1 of the new records 410b. If any record from 410b are to be written into existing database 420b, then missing records in range it2-nt1 will always be imported into this existing database 420b without exception. This happens because databases are arranged chronologically.

Time gap 430b is considered free hours. Free hours may be the value that tells how far beyond it2 new records can be imported into the existing database 420b. If free hours added to it2 contains nt1, then some or all of the new records from 410b can go into the existing database. If free hours falls between nt1 and nt2 then some of the records in 410b (nt1+free hours) will be imported into the existing database 420b. If free time extends beyond nt2 then all of the new record 410b will be imported into the existing database 420b. If free time ends before nt1, then no records from new records 410b can be imported into 420b.

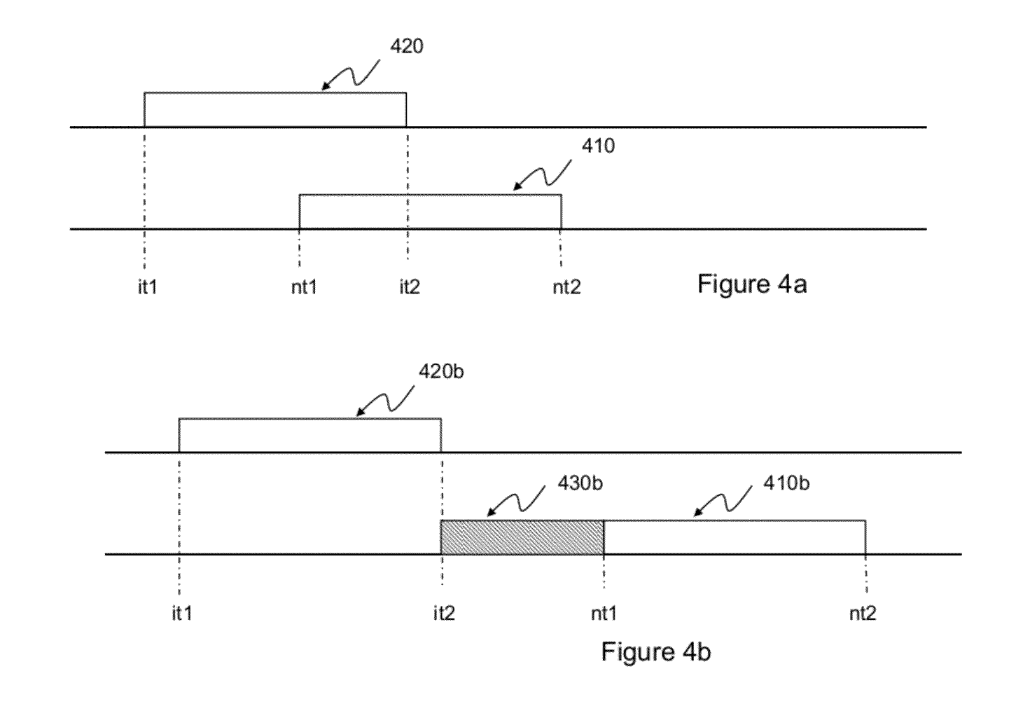

In an embodiment, a database whose start timestamp falls after the start timestamp of extraction may be extended to append records together. In an embodiment, if there is no existing database prior to start timestamp of a new extraction or if one exist, the database may be full or the time gap is so large, that it cannot be used to insert records from new extraction. Then, the system must evaluate the existing databases whose start timestamp is greater than the start timestamp of current extraction to see if it can be extended. As seen in FIG. 5a, consider an existing database having records with following time range. Free time 500 beginning at ft1-et1 and an exiting entry 510 from et1 to et2. Consider adding new extractions 520 with a time range of nt1-nt2. After the free hours of the existing database are calculated, it will be determined if ft1-et1 includes the start of the new extraction nt1. If nt1 falls within ft1-et1, then the new extraction can go into the existing database as long as there is sufficient free time 500. Depending on the value of ft1 and the range nt1-nt2, several scenarios are possible. As noted, where ft1 precedes nt1, and nt2 is before et1, then all the new records may be imported into the existing database. If however, as seen in FIG. 5b the new record 550 starts before free time 530 at nt1, only a portion of the new records 550 can go into the existing database 540 from the range ft1-nt2. For the remaining portion, nt1 to ft1 a new database will need to be created. As will be appreciated by those skilled in the art, this step only executes when no previous time range database is available for new records.

Once a new database is created, it may be used to import records till it meets or exceeds its preset size limit. In an embodiment, existing records with the same timestamp are not retained in more than one database at a time. Accordingly, where records exist in an existing database with the same timestamp as records attempting to be imported, the new records will overwrite the existing records, though the system can be configured so that the new records do not overwrite the existing records. Where the records do not overlap completely, a new database may be created to gather the non-duplicated records.

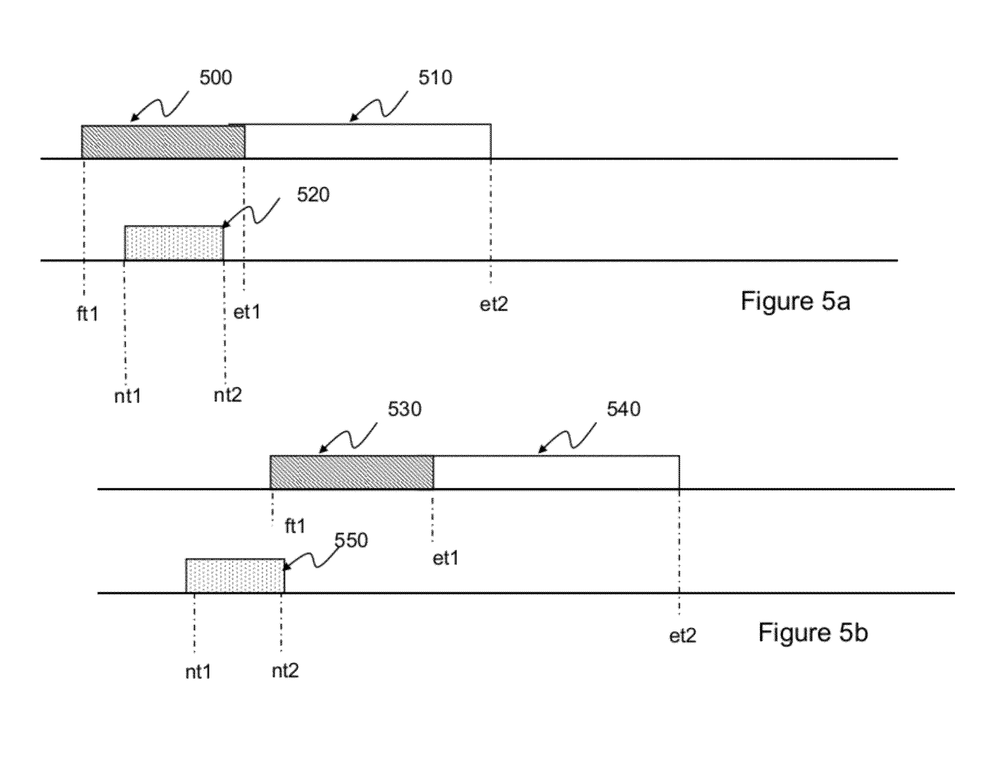

In an embodiment, the free hours in any existing database, i.e., the space still available before the database is full, may be calculated, as follows. As seen in FIG. 6, an existing database has data written in range 600 and 610 and has a time range of et1-et2, with empty records or hole 620 in the time range from ht1-ht2. With a maximum size limit of 5 GB, assume current size of records 600 and 610 is 3 GB. Free 2 GB cannot be used without further check to import new records because when missing records 620 for the hole is imported, it will grow the database size. It means all of the 2 GB free is not available for new imports. Accordingly, in an embodiment, the available free size in the database can be computed based on the maximum size, current size and available records 600 and 610. A value of the database size per hour of data is calculated based on the database size and the data present, i.e., areas 600 and 610 in the database. Balance intervals present in database are counted and this count is considered as the total minutes of data present in the database. Using this value an actual time span of data hours is calculated. Where data hours=actual hrs of data present in database based on the balance interval present. In a system using one minute intervals, 60 balance intervals means that there is one hour of data. Accordingly, in an embodiment, the database size per hour of data=database size in GB/data hours; start timestamp will be et1 and end timestamp will be et2 for this database in the database table. The total time span of database i.e. et1-et2 will be calculated in hours. This may be termed as database full hours. Next the system calculates how large the database will grow when all the missing records are filled. Database Full Size=(Database Size Per Hour of Data*Database Full Hours). For example, with reference to FIG. 6, assume that et1-ht1=2 hrs, ht1-ht2=1 hr and ht2-et2=1 hr. Therefore, data hours=3 hr; database size per hour of data=3/3 or 1 GB/Hr; database full hours=4 hours and database full size=4×1=4 GB. Accordingly, in this example, one GB is available for any new records i.e., free GBs=1.

In one embodiment, a table may be created that will keep information about all the individual databases, their location, time range of data present in them, their completeness and vacuumed status. The new table may contain the following information, although other information is possible.

TABLE 2

| Column Name | Type | Description |
|---|---|---|
| db_id | Integer | Unique numeric value assigned to |
| | (Primary Key) | a database file that the archive |
| | | is aware of. |
| host_id | Integer | Host for which this repository |
| | (Foreign Key | contains the data. |
| | on host | |
| | table) | |
| start_nominal_{—} | Datetime | Time stamp of the first balance |
| timestamp | | interval record stored in the |
| | | archive. |
| end_nominal_{—} | Datetime | Time stamp of the last balance |
| timestamp | | interval record stored in the |
| | | archive. |
| db_path | Text | Path to the database file located |
| | | on disk. |
| db_state | Integer | An enumeration value indicating |
| | | state of the database. Values map |
| | | as follows: |

| | |
|---|---|
| Value | Description |
| 0 | Database is not |
| | vacuumed and is not |
| | fully populated with |
| | records. |
| 1 | Database is fully |
| | populated with records |
| | but has not been |
| | vacuumed. |
| 2 | Database is fully |
| | populated with records |
| | and has been vacuumed. |

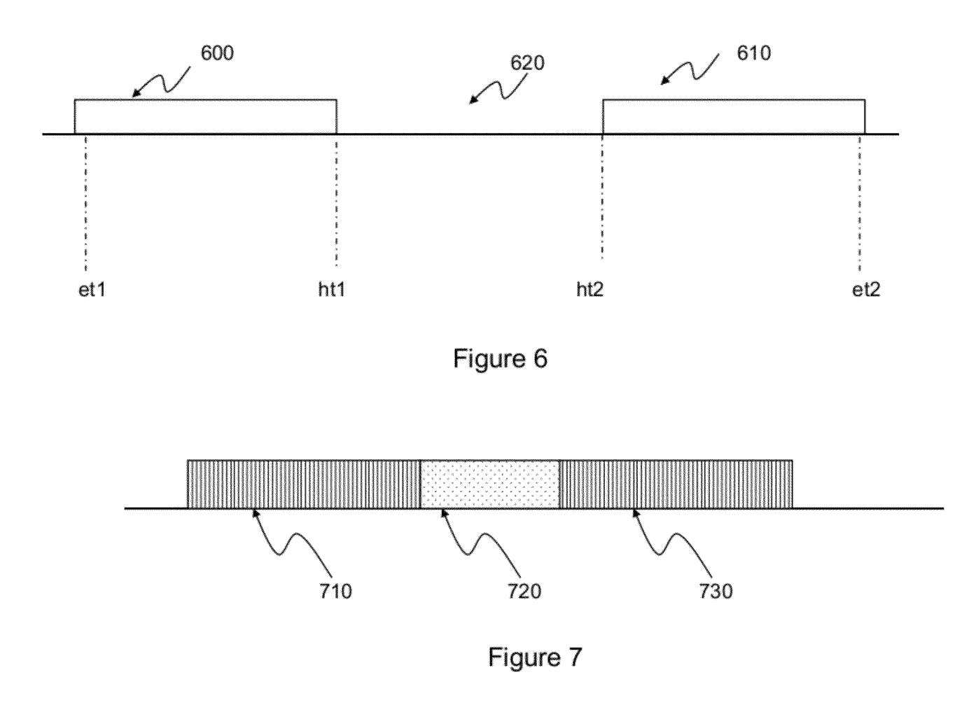

In one embodiment, scheduled maintenance and data extraction from the fragmented files are performed in accordance with traditional methods. In another embodiment, repository maintenance process will first identify the databases that can be marked as complete. A database may be marked as complete if its size has reached the maximum size limit set by the system. In the case of manual extractions, it is likely that database with sizes less than the maximum size will not receive new records. This happens when out of turn manual extractions are done at intervals before scheduled extractions runs. For example if an individual database 720 is created of a less than complete size, between two full size database 710 and 730 as shown in FIG. 7, there will be records on a continuous time basis despite the fact that the database 720 is less then a complete size. In such a case, database 720 may be considered as final and may be vacuumed to reduce storage size.

In one embodiment, because vacuuming is a time intensive operation, only one database will be vacuumed during a scheduled maintenance run. It will be appreciated, that the system is not limited to one vacuuming operation at a time, as long as sufficient system resources and time allocations are such that multiple vacuuming operations may be performed simultaneously. Additionally, due to the nature of the vacuuming process, the operation can not be cancelled in the middle of the vacuuming process.

In one embodiment, the individual fragmented files are vacuumed at a regularly scheduled maintenance interval after they have been completely populated and/or filled with data. This automatic vacuuming of the individual fragmented files further reduced the overall storage requirements and increases file manageability. Such vacuuming in an embodiment can be performed during a maintenance period that can be scheduled in a similar manner to automated extractions. During the maintenance period database table, the index of the repository, is queried to produce list of fragmented files that are complete but have not been vacuumed. The most recent eligible fragmented files will be vacuumed during the maintenance period.

In one embodiment, there is an interface that retrieves the data from multiple databases and will present the user an interface that has all the functionalities of a database reader for a single unitary database. In an embodiment, if the user's query is a simple select statement that does not include any Group By or Order By clause then the query will be executed in each fragmented database and will be presented to the user in order of each database. On the other hand, if the query involves Group By or Order By clause, then the system may attach each fragmented database into the main database context and create temporary tables in the main database for the specified query by getting and executing select query in the fragmented databases. Once all the data is populated into the temporary table the fragmented database will be detached. The process will repeat for all the fragmented databases. Finally when all the fragmented databases are attached and all the temporary tables corresponding to each individual database are created then a Master Temporary table will be created by selecting all the records from each of the temporary tables. The query will be executed in this final Master temporary table to get the actual result set in the order of the Group By or Query By.

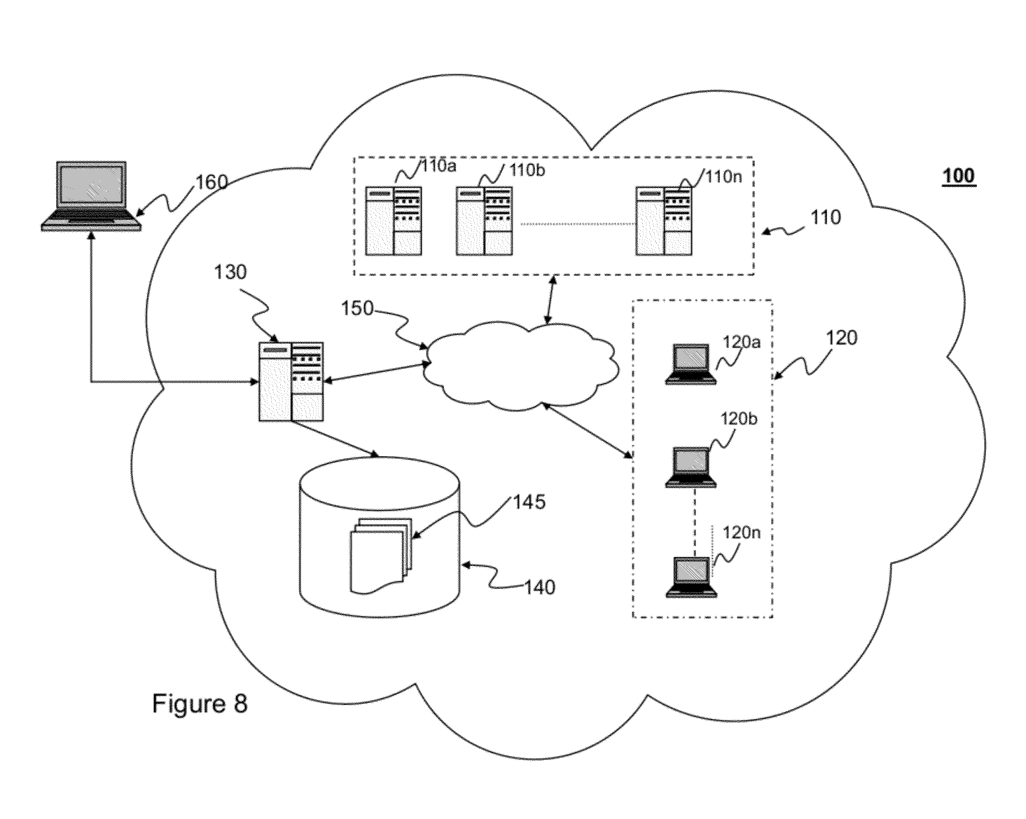

FIG. 8 depicts an exemplary embodiment, wherein system 100 is implemented in cloud computing environment 180. In this embodiment all or some of system 100 may be implemented in a cloud infrastructure environment. For example, database 140 and fragmented files 145 may reside in a cloud environment. Likewise, processors 110, user input terminals or computers 120, management server 130, database 140, fragmented files 145 and network 150

As used herein, Cloud computing may be a model, system or method for enabling convenient, on-demand network access to a shared pool of configurable computing resources (e.g., networks, servers, storage, applications, and services) that can be rapidly provisioned and released with minimal management effort or service provider interaction. A cloud computing environment provides computation, software, data access, and storage services that do not require end-user knowledge of the physical location and configuration of the system that delivers the services. Cloud computing infrastructure may be delivered through common centers and built-on servers and memory resource.

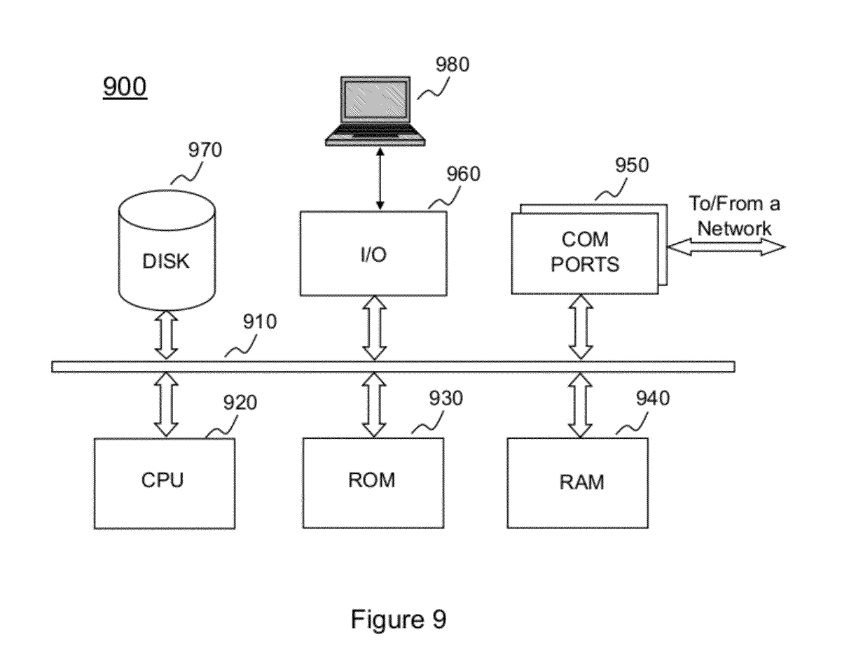

FIG. 9 depicts a general computer architecture on which the instant disclosure can be implemented and has a functional block diagram illustration of a computer hardware platform which includes user interface elements. The computer may be a general purpose computer or a special purpose computer. This computer 900 can be used to implement any component of system 100 as described herein. For example, processors 110, user input terminals, 120, management server 130, database 140 fragmented files 145 network 150 or user terminal 160 can all be implemented on a computer such as computer 900, via its hardware, software program, firmware, or a combination thereof. Although only one such computer is shown, for convenience, the computer functions relating to automated migration may be implemented in a distributed fashion on a number of similar platforms, to distribute the processing load.

The computer 900, for example, includes COM ports 950 connected to and from a network connected thereto to facilitate data communications. The computer 900 also includes a central processing unit (CPU) 920, in the form of one or more processors, for executing program instructions. The exemplary computer platform includes an internal communication bus 910, program storage and data storage of different forms, e.g., disk 970, read only memory (ROM) 930, or random access memory (RAM) 940, for various data files to be processed and/or communicated by the computer, as well as possibly program instructions to be executed by the CPU. The computer 900 also includes an I/O component 960, supporting input/output flows between the computer and other components therein such as user interface elements 980. The computer 900 may also receive programming and data via network communications.

Hence, aspects of the methods of fragmenting files, e.g., portioning large monolithic files into unique fragmented files may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software or systems may at times be communicated through a network such as the Internet or various other telecommunication networks. Such communications, for example, may enable loading of the software from one computer or processor into another, for example, from a host server or host computer into the hardware platform(s) of a computing environment or other system implementing a computing environment or similar functionalities of the management server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will recognize that the instant disclosures are amenable to a variety of modifications and/or enhancements. For example, although the implementation of various components described above may be embodied in a hardware device, it can also be implemented as a software only solution—e.g., an installation on an existing server. In addition, the components as disclosed herein can be implemented as a firmware, firmware/software combination, firmware/hardware combination, or a hardware/firmware/software combination.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the instant disclosures.

What is claimed is:

1. A method, for partitioning files on a machine having at least one processor, storage, and a communication platform comprising the steps of:
storing data, received over the communications platform, in a database;
tracking a criteria for the data utilizing at least one processor;
partitioning the database into a plurality of databases based on the criteria; and
maintaining an index of the plurality of databases.

2. The method of claim 1 wherein the criteria is at least one of the following:
a temporal limit, a size limit, a data source, a data type and a geographic limit.

3. The method of claim 1 wherein the index contains characteristics of the plurality of databases.

4. The method of claim 3, wherein the characteristics include at least one of the following:
a database name, a server name, a start time, an end time, a system path and a status identifier.

5. The method of claim 1 further comprising:
computing the amount of free space in the plurality of database, and
storing an amount of additional information in the plurality of databases based on the computing.

6. The method of claim 5 further comprising:
creating an additional one of a plurality of databases if the computed amount of free space is less then the amount of additional information.

7. The method of claim wherein the database sizes of the plurality of databases is limited so that an individual database can be vacuumed using known techniques.

8. The method of claim 7, where the vacuuming of the individual databases can be completed within 2 to 6 hours.

9. The method of claim 1 wherein the database sizes of the plurality of databases is limited to a size such that an NTFS compression scheme may be applied to plurality of databases

10. A method for retrieving information from a plurality of databases on a machine having at least one processor, storage, and a communication platform comprising the steps of:
creating a table comprising characteristics of the plurality of databases;
receiving a query on the machine;
processing the query with the processor to determine the location of the information within the plurality of databases based on the characteristics in the table;
retrieving the information from the plurality of databases; and
communicating that information over the communications platform back to the machine.

11. A machine readable non-transitory and tangible medium having information recorded thereon for partitioning files on a machine having at least one processor, storage, and a communication platform, to causes the machine to perform the following:
storing data, received over the communications platform, in a database;
tracking a criteria for the data utilizing at least one processor;
partitioning the database into a plurality of databases based on the criteria; and
maintaining an index of the plurality of databases.

12. The medium of claim 11 wherein the criteria is at least one of the following:
a temporal limit, a size limit, a data source, a data type and a geographic limit.

13. The medium of claim 11 wherein the index contains characteristics of the plurality of databases.

14. The medium of claim 13, wherein the characteristics include at least one of the following:
a database name, a server name, a start time, an end time, a system path and a status identifier.

15. A system for partitioning files comprising:
a first system for implementing a first application;
a data capture system for receiving data from the first system;
a communications link for conveying the data from the first system to a data capture system;
a data partitioning system for partitioning the data into partitioned data files;
a data storage system for storing the partitioned data files, and
a data indexing system for tracking the partitioned files.
